(19) United States
(12) Patent Application Publication
(10) Pub. No.: US 2009/0139474 A1
(43) Pub. Date: Jun. 4, 2009

(54) Air-to-air aftercooler

(75) Inventor: Mahesh Kumar Mokire, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/987,524

(22) Filed: Nov. 30, 2007

(51) Int. Cl. F02B 29/04; F01P 11/12; F02B 33/00

(52) U.S. Cl. 123/41.58; 123/563; 165/144; 60/599

(57) ABSTRACT

An air-to-air aftercooler is disclosed. The air-to-air aftercooler includes at least one core assembly and two inlet lines connected to the core assembly. The air-to-air aftercooler may also include a single outlet line configured to direct cooled charge air to an intake manifold of an engine.

### TECHNICAL FIELD

The present disclosure relates to an air-to-air aftercooler, and more particularly, to an air-to-air aftercooler having two inlet lines and a single outlet line.

### BACKGROUND

Construction and earthmoving equipment, as well as many other types of machines, are commonly used in a wide variety of applications. Generally, such a machine is powered by an internal combustion engine. In order to enhance the performance of the machine, the engine must perform as efficiently as possible. Because many machines are powered by internal combustion engines, various methods have been developed to increase internal combustion engine efficiency. One method has been to incorporate a turbocharger into the internal combustion engine. The turbocharger may compress air prior to entering an engine intake manifold or combustion chamber. Supplying the engine intake manifold with compressed air (“charge air”) may allow for more complete combustion. This may result in lower emissions, improved performance, and better engine efficiency. However, compressing the air may also cause an increase in the intake air temperature. Supplying the engine intake manifold with such heated charge air may lead to an undesirable increase in the amount of emissions exiting from the engine. An air-to-air aftercooler (ATAAC), positioned downstream of the turbocharger, may be used to reduce smoke and other engine emissions by cooling the charge air before it enters the engine intake manifold.

Larger machines require an increased mass flow rate of charge air to meet engine performance and emission targets. This requires large aftercoolers with physical sizes exceeding current brazing oven size limitations. As a result, two smaller ATAACs are used to accommodate the heat load. Each ATAAC module may be composed of a core, a high pressure duct (inlet duct) communicating with a high pressure compressor, and an outlet duct communicating with the inlet manifold of the engine. In an alternative modification, twin aftercoolers may be combined into a single unit. Examples of these arrangements are described in U.S. Pat. No. 5,692,378 (the '378 patent) issued to Ramsden on Dec. 2, 1997.

Though successful in its intended purpose, large machines having two ATAACs are disadvantaged. The inlet and outlet duct of each ATAAC core may create a packaging problem, as each inlet and outlet duct must be routed around the engine. Furthermore, the outlet ducts, each having a 4-6″ diameter, may block the cold air stream within the cooling package. This may reduce the overall cooling performance of the cooling system.

The air-to-air aftercooler of the present disclosure is directed towards improvements in the existing technology.

### SUMMARY

One aspect of the present disclosure is directed towards an air-to-air aftercooler. The air-to-air aftercooler includes at least one core assembly and two inlet lines connected to the core assembly. The air-to-air aftercooler may also include a single outlet line configured to direct cooled charge air to an intake manifold of an engine.

Another aspect of the present disclosure is directed towards a method of assembling an air-to-air aftercooler having at least one core assembly and two inlet lines. The method includes securing the two inlet lines to the sides of the core assembly at opposing ends of the core assembly. The method further includes securing a single outlet line substantially center to the two inlet lines to the core assembly.

### BRIEF DESCRIPTION OF THE DRAWINGS

FIG. 1 is a diagrammatical illustration of a machine provided with an air-to-air aftercooler (ATAAC) according to an exemplary disclosed embodiment; and

FIG. 2 is a diagrammatic view of an air-to-air aftercooler for a machine according to an exemplary disclosed embodiment.

### DETAILED DESCRIPTION

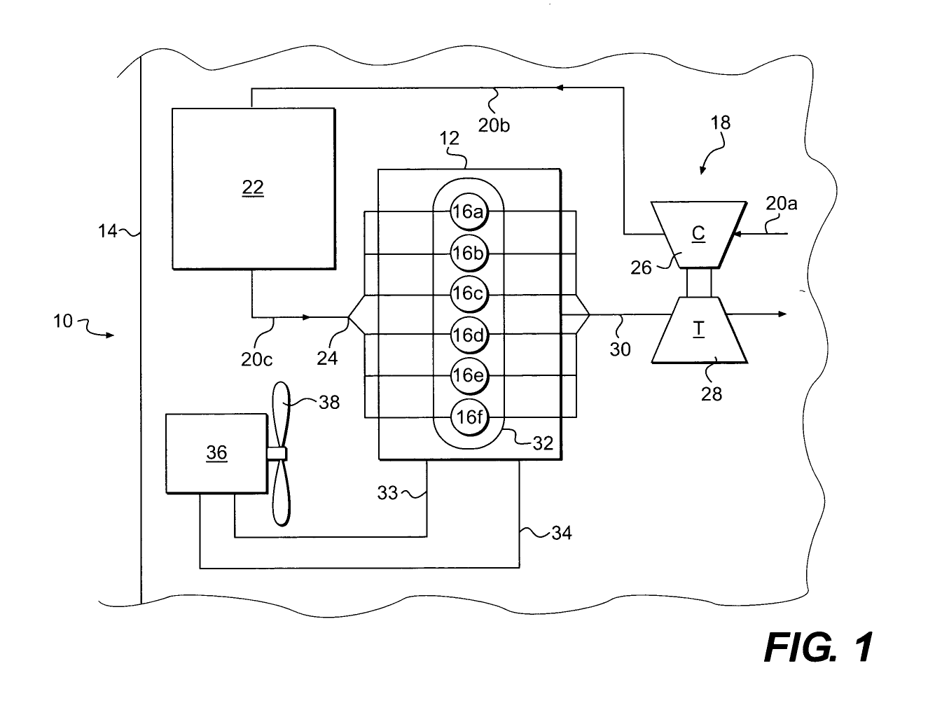

FIG. 1 diagrammatically illustrates an exemplary machine 10. Exemplary machine 10 may be any type of construction or earthmoving equipment. The outline represents a portion of the chassis of machine 10. An engine 12 may be mounted on chassis 14. Engine 12 may be any type of internal combustion engine such as, for example, a diesel engine, a gasoline engine, a gaseous fuel powered engine, a heavy fuel engine, or any other type of engine apparent to one skilled in the art.

In the illustrative example, engine 12 is shown with six combustion chambers 16a-16f for generating power, each provided with a piston, one or more intake valves, one or more exhaust valves, and other components (not shown) known to those having skill in the art. Combustion chambers 16a-16f of engine 12 may be disposed in an “in-line” configuration, a “V” configuration, or another suitable configuration. In some engine configurations there may be separate banks of combustion chambers 16a-16f. For example, in a “V” configuration, there may be two banks of combustion chambers.

Engine 12 may include a turbocharger 18 for compressing intake air 20a to form compressed charge air. Due to the heat of compression, compressed charge air exits turbocharger as heated charge air 20b and is directed to an air-to-air aftercooler (ATAAC) 22. Large machines may employ multiple ATAAC modules, to accommodate the volume of heated charge air 20b. ATAAC 22 cools heated charge air 20b prior to entering an air intake manifold 24. In the exemplary embodiment of FIG. 1, one turbocharger is illustrated, but it will be understood that the number of turbochargers could be one or more than one and still fall within the scope of this disclosure. Alternatively, an engine driven supercharger or superchargers may be employed to compress intake air 20a forming heated charge air 20b.

Turbocharger 18 may include a compressor 26, powered by a turbine 28 driven by engine exhaust flow 30. The compressor 26 may pressurize intake air 20a to allow a greater mass of fuel/air mixture in the engine cylinders of engine 12. The result may be an increase in power and improved engine efficiency. However as a byproduct of pressurization, the temperature of intake air 20a may also increase, which may be undesirable. The compressed intake air 20a exiting compressor 26 may conveniently be referred to as heated charge air 20b. As noted above, heated charge air 20b may be cooled prior to entering air intake manifold 24 by passing through ATAAC 22. Thus, ATAAC 22 may be provided downstream of a compressor 26 and upstream of air intake manifold 24.

To dissipate the relatively large amount of heat generated directly in engine 12 by the combustion process in combustion chambers 16a-16f, engine 12 may be provided with a system of passageways 32. Passageways 32 may connect, via suitable lines 33, 34 for example, to a radiator assembly 36. A suitable liquid coolant may circulate within passageways 32, lines 33, 34, and radiator assembly 36, whereby heat from engine 12 may be transferred to radiator assembly 36. Radiator assembly 36 may be suitably mounted at the front of machine 10 where dissipation of heat from radiator assembly 36 to ambient air may be facilitated by radiation with or without the aid of a suitable fan 38, such as a motor driven fan, and/or by movement of machine 10.

The ATAAC 22 and radiator assembly 36 may be serially arranged such that ATAAC 22 is upstream of radiator assembly 36. ATAAC 22 may then be configured to engage a front side of radiator assembly 36. In an alternative arrangement ATAAC 22 and radiator assembly 36 may be mounted in the same plane, for example side by side.

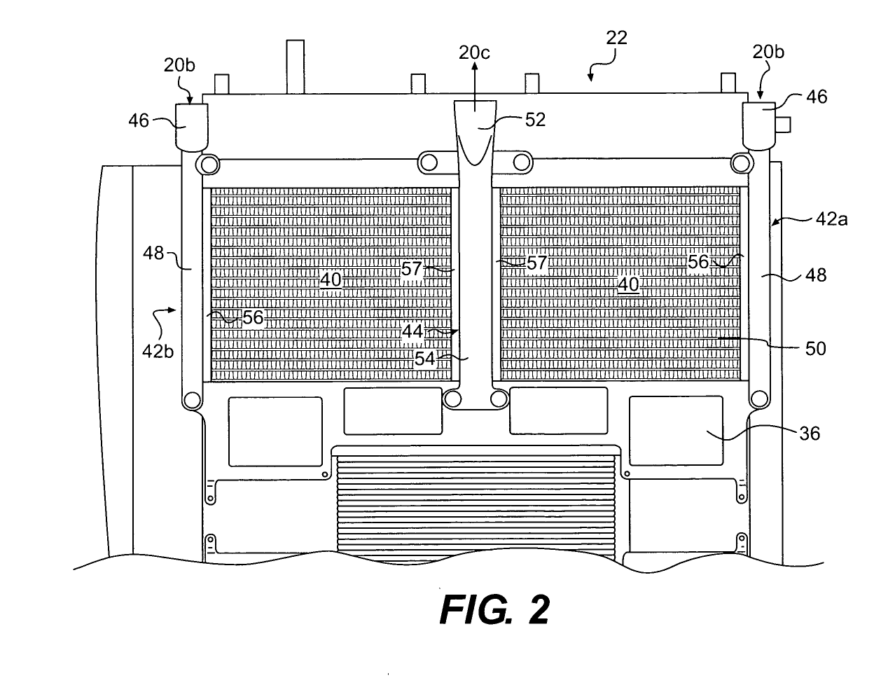

FIG. 2 illustrates an exemplary embodiment of ATAAC 22 mounted in front of a radiator assembly 36. ATAAC 22 may include at least one core assembly 40, two inlet lines 42a, 42b, and a single outlet line 44. Outlet line 44 may be configured to direct cooled charge air 20c to an intake manifold 24 of engine 12.

Inlet lines 42a, 42b of ATAAC 22 may be configured to admit heated charge air 20b into ATAAC. For example, inlet lines 42a, 42b may include an inlet tank 46 in fluid communication with compressor 26 of turbocharger 18. Inlet lines 42a, 42b may further include an inlet manifold 48, extending from inlet tank 46, configured to direct heated charge air 20b from inlet tank 46 into core assembly 40 of ATAAC 22 for cooling. Inlet lines 42a, 42b may be disposed adjacent to core assembly 40 of ATAAC 22 at opposing ends of ATAAC 22 so as to substantially avoid blocking ambient air flow around core assembly 40.

Core assembly 40 of ATAAC 22 may be configured to cool heated charge air 20b. For example, core assembly 40 may include one or more tubes 50 through which the heated charge air 20b may pass. The outside of tubes 50 may be subjected to some type of fluid, for example, ambient air, which may cool tubes 50. As the heated charge air 20b passes through tubes 50, it may come into contact with tube walls. Heat may be transferred from charge air to tube walls, and then from tube walls into the ambient air, thus removing heat from the charge air. In some embodiments, external fins (not shown) may be added to the external surfaces of tube walls to create greater surface area for heat transfer.

Outlet line 44 of ATAAC may be configured to exhaust cooled charge air 20c from ATAAC 22. Specifically, outlet line 44 may include an outlet tank 52 and an outlet manifold 54 extending from the outlet tank 52. Outlet manifold 54 may remove cooled charge air 20c from core assembly 40 of ATAAC 22. Outlet tank 52, may conduct cooled charge air 20c to intake manifold 24 of engine 12. As shown in FIG. 1, intake manifold 24 of engine 12 may include one or more passages or conduits which may be used to conduct cooled charge air 20c to one or more combustion chambers 16a-16f.

In the exemplary embodiment shown in FIG. 2, inlet manifold 48 of inlet lines 42a, 42b and outlet manifold 54 of outlet line 44 are shown in connection with headers 56, 57. Headers 56, 57 may include a design, such as one including one piece or a single component. In another exemplary embodiment, headers 56, 57 may include a design such as one made from modular components which may be fitted together to form a unitary assembly.

In one embodiment as shown in FIG. 2, engine 12 may be of an “in-line” arrangement, having an ATAAC 22 downstream of engine 12. ATAAC 22 may have at least one core assembly 40 with two inlet lines 42a, 42b disposed on either side of core assembly 40. ATAAC 22 may further include a single outlet line 44 disposed substantially between the two inlet lines 42a, 42b and associated with the assembly 40. In an alternative embodiment, engine 12 may be of a “V” configuration having two core assemblies 40 of ATAAC 22 disposed on either side of the “V”. Each inlet line may be sideways from the compressors located on each bank of the “V”. In addition, a single outlet line 44 may be disposed between two core assemblies 40 at the center of the “V”.

Core assembly 40, inlet lines 42a, 42b, and outlet line 44 of ATAAC 22 may be pre-assembled components which may be joined together to form a final ATAAC assembly 22. It is contemplated, that one method of joining components may include welding of inlet and outlet lines to core assembly 40. Another method may include brazing or joining of metals through the use of heat and a filler metal (e.g., a metal with a melting temperature below the melting point of the metals being joined). It is contemplated that two inlet lines 42a, 42b and a single outlet line 44 may be welded and/or brazed to at least one core assembly 40 to form a final ATAAC assembly 22. It is further contemplated that multiple modular core assemblies 40 may be brazened together and then welded to a common outlet line 44.

### INDUSTRIAL APPLICABILITY

The disclosed ATAAC may have applicability with internal combustion engines. In particular, and as shown in FIG. 1 and FIG. 2, the ATAAC may serve to cool a flow of heated charge air exiting a compressor of a turbocharger before it enters an air intake manifold of an engine, thus decreasing the level of emissions and increasing the life of engine components.

In a machine 10, exhaust 30 leaving engine 12 may be directed towards a turbine 28 of turbocharger 18. The flow of exhaust 30 may power turbine 28, causing it to rotate and drive compressor 26. Intake air 20a may be directed into compressor 26 where in may undergo compression, and as a byproduct of compression, intake air 20a may also be heated into heated charge air 20b. Heated charge air 20b may travel from compressor 26 into ATAAC 22 through an inlet tank 46, where it may be directed into an inlet manifold 48. Tubes 50 of core assembly 40 may be in fluid communication with inlet manifold 48 of ATAAC 22, and thus, heated charge air 20b may pass from inlet manifold 48 into tubes 50 to undergo a heat exchange with cooler ambient air. Tubes 50 may direct cooled charge air 20c into an outlet manifold 54 towards outlet tank 52. Outlet tank 52 may be in communication with intake manifold 24 of engine 12. Upon exiting ATAAC 22, cooled charge air 20c may be mixed with fuel within one or more combustion chambers 16a-16f within engine 12. Because cooler air has greater density than heated air, a volume of cooled charge air 20c at a certain pressure may contain a greater number of air molecules than the same volume of heated charge air 20b at that same pressure. Increasing the number of air molecules in combustion chambers 16a-16f of engine 12 may decrease the amount of smoke and/or emissions exiting from engine 12, improve engine performance, and improve engine efficiency. Also reducing the temperature of heated charge air 20b may decrease the operating temperature of engine 12, thus resulting in less wear on engine components.

Larger machines 10 may require a larger ATAAC 22 to accommodate the machine heat load. To meet the cooling requirements of machine 10 while providing a simple cooling package, ATAAC 22 may be provided with at least one core assembly 40, two inlet lines 42a, 42b, and a single outlet line 44. By having a single outlet line 44, ATAAC 22 may reduce the obstruction of air flow to downstream cooling components, such as, for example, radiator assembly 36. Additionally, by having a single outlet line 44, core assembly 40 of ATAAC 22 may have a greater surface area exposed to ambient air for heat transfer. This may lead to improved cooling system performance.

Furthermore, core assembly 40, inlet lines 42a, 42b, and outlet lines 44 of ATAAC 22 may be pre-assembled components which may be joined together to form a final ATAAC assembly 22. Hence a combination of mixed components, such as tubes 50, pre-assembled headers 56, 57, inlet manifold 48, and outlet manifold 54, may be assembled and subsequently subjected to a brazing operation to produce a final ATAAC 22. In one embodiment, two core assemblies 40 may be brazed together and to a single outlet line 44 to accommodate cooling requirements for larger machines 10.

It will be apparent to those skilled in the art that various modifications and variations can be made to the air-to-air aftercooler (ATAAC) of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. An air-to-air aftercooler, comprising:
at least one core assembly;
two inlet lines; and
a single outlet line configured to direct cooled charge air to an intake manifold of an engine.

2. The air-to-air aftercooler of claim 1, wherein the two inlet lines are disposed adjacent to the core assembly at opposite ends of the core assembly, the inlet lines configured so as to substantially avoid blocking air flow to the core assembly.

3. The air-to-air aftercooler of claim 1, wherein the inlet lines include inlet tanks in fluid communication with at least one compressor of a turbocharger.

4. The air-to-air aftercooler of claim 3, wherein the inlet lines further include inlet manifolds extending from the inlet tanks, the inlet manifolds configured to direct heated charge air to the core assembly.

5. The air-to-air aftercooler of claim 1, wherein the at least one core assembly includes two core assemblies, each core assembly in communication with one inlet line, the core assemblies sharing the single outlet line.

6. The air-to-air aftercooler of claim 1, wherein the outlet line includes an outlet tank, the outlet tank in fluid communication with the intake manifold of the engine.

7. The air-to-air aftercooler of claim 6, wherein the outlet line further includes an outlet manifold extending from the outlet tank, the outlet manifold configured to remove cooled charge air from the at least one core assembly.

8. The air-to-air aftercooler of claim 1, wherein the core assembly includes at least one tube configured to direct flow of charge air.

9. The air-to-air aftercooler of claim 8, further including a first header coupled to a first end of the at least one tube and a second header coupled to a second end of the at least one tube.

10. A method of assembling an air-to-air aftercooler, the air-to-air aftercooler including at least one core assembly and two inlet lines, the method comprising:
securing the two inlet lines to the sides of the core assembly at opposing ends of the core assembly; and
securing a single outlet line substantially center to the two inlet lines to the at least one core assembly.

11. The method of claim 10, including two core assemblies, and further include brazing the two core assemblies.

12. The method of claim 11, wherein securing the two inlet lines and single outlet line includes securing the two inlet lines to a first header and securing the single outlet line to a second header of each core assembly.

13. The method of claim 10, wherein the inlet line includes an inlet tank and an inlet manifold extending from the inlet tank.

14. The method of claim 10, wherein the outlet line includes an outlet tank and an outlet manifold extending from the outlet tank.

15. An engine assembly, comprising:
at least one turbocharger configured to compress intake air before it enters an air intake manifold;
a radiator; and
an air-to-air aftercooler located upstream of the radiator assembly, the air-to-air aftercooler comprising:
at least one core assembly;
two inlet lines; and
a single outlet line, the outlet line configured to deliver cooled charge air to an intake manifold of the engine.

16. The engine assembly of claim 15, wherein the radiator is in series with the air-to-air aftercooler.

17. The engine assembly of claim 15, wherein the at least one core assembly includes two core assemblies, each core assembly in communication with one inlet line, the core assemblies sharing the single outlet line.

18. The engine assembly of claim 17, wherein the two inlet lines are disposed adjacent to the two core assemblies at opposing ends of the air-to-air aftercooler, the inlet lines configured so as to substantially avoid blocking air flow to the core assemblies.

19. The engine assembly of claim 15, wherein the two inlet lines include inlet tanks in fluid communication with the at least one turbocharger.

20. The engine assembly of claim 15, wherein the two inlet lines and single outlet line are welded to the core assembly.
